(19) United States
(12) Patent Application Publication
(10) Pub. No.: US 2019/0114131 A1
(43) Pub. Date: Apr. 18, 2019

(54) CONTEXT BASED OPERATION EXECUTION

(71) Applicant: Microsoft Technology Licensing, LLC, Redmond, WA (US)

(72) Inventors: Gregg R. WYGONIK, Duvall, WA (US); Robert J. DISANO, Seattle, WA (US); Jan-Kristian MARKIEWICZ, Redmond, WA (US); Sophors KHUT, Seattle, WA (US); Christian KLEIN, Duvall, WA (US)

(73) Assignee: Microsoft Technology Licensing, LLC, Redmond, WA (US)

(21) Appl. No.: 15/783,577

(22) Filed: Oct. 13, 2017

(51) Int. Cl. G06F 3/14

(52) U.S. Cl. CPC G06F 3/1423; G06F 3/04842

(57) ABSTRACT

A system for executing context based operations can include a processor and a memory device comprising a plurality of instructions that, in response to an execution by the processor, cause the processor to detect context information corresponding to input wherein the context information comprises device information, a subject of the input, device usage information, or a combination thereof. The processor can also store a link between the context information and the input. Additionally, the processor can detect an operation corresponding to the context information and the input and execute the operation based on the context information and the input.

### BACKGROUND

Computer devices can be coupled to any suitable number of display screens. In some examples, multiple display screens can display application windows for a common user interface. In some examples, the application windows can include an input panel that can detect user input. The user input can be provided to the input panel while viewing additional content on other interconnected display devices.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

An embodiment described herein includes a system for context based operations that can include a processor and a memory device comprising a plurality of instructions that, in response to an execution by the processor, cause the processor to detect context information corresponding to input, wherein the context information comprises device information, a screenshot of a user interface, device usage information, or a combination thereof. The processor can also detect an operation corresponding to the context information and the input and execute the operation based on the context information and the input.

In another embodiment, a method for context based operations can include detecting context information corresponding to input, wherein the context information comprises device information, device usage information, or a combination thereof, wherein the device information indicates two display screens are connected to a device and the context information corresponds to a first of the two display screens and the input is detected with a second of the two display screens. The method can also include storing a link between the context information and the corresponding input and detecting an operation corresponding to the context information. Furthermore, the method can include executing the operation based on the context information and the corresponding input, wherein the operation comprises a reverse search query based on the context information, and wherein a result of the reverse search query comprises previously detected input corresponding to the context information.

In yet another embodiment, one or more computer-readable storage media for context based operations can include a plurality of instructions that, in response to execution by a processor, cause the processor to detect context information corresponding to input, wherein the context information comprises device information, a subject of the input, device usage information, or a combination thereof, wherein the device information indicates two display screens are coupled to a system and the context information corresponds to a first of the two display screens and the input is detected with a second of the two display screens. The plurality of instructions can also cause the processor to store a link between the context information and the corresponding input, detect an operation corresponding to the context information and the input, and execute the operation based on the context information and the input.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

The following detailed description may be better understood by referencing the accompanying drawings, which contain specific examples of numerous features of the disclosed subject matter.

FIG. 1 is a block diagram of an example of a computing system that can execute context based operations;

FIG. 2 is a process flow diagram of an example method for executing context based operations;

FIG. 3 is an example block diagram illustrating a modified user interface for executing context based operations; and

FIG. 4 is a block diagram of an example computer-readable storage media that can execute context based operations.

### DETAILED DESCRIPTION

User interfaces can be generated using various techniques. For example, a user interface can include any suitable number of applications being executed, operating system features, and the like. In some embodiments, multiple display screens can be electronically coupled to one or more systems to provide a representation of a user interface across the multiple display screens. Accordingly, input panels for detecting user input can be displayed on a first display screen while additional content is displayed on a second interconnected display screen. In some embodiments, the visible content from the second display screen, among other information, can be stored as context information corresponding to the input provided to an input panel visible via a first display screen. In some embodiments, the context information can include additional data such as a device configuration, device usage information, user position information, and the like.

Techniques described herein provide a system for executing context based operations. A context based operation, as referred to herein, can include any instructions executed based on input linked to corresponding context information. In some embodiments, the context information can include device information, a subject of the input, device usage information, user position information, device location information, a screenshot of a user interface or a portion of a user interface, or a time of day corresponding to detected input, among others. In some examples, context information can include any suitable aggregated or combined set of data corresponding to detected input. In some examples, the context information can be detected based on any suitable user interface. A user interface, as referred to herein, can include any suitable number of application windows, operating system features, or any combination thereof. The application windows can provide a graphical user interface for an actively executed application that is viewable via any number of display screens. In some embodiments, a system can detect context information corresponding to input provided to a first display screen. As discussed above, the context information can include data associated with the input such as the content displayed by display screens adjacent to an input panel, among others. In some embodiments, a system can store a link between detected input and context information. The system can also detect an operation corresponding to the context information and the input. Furthermore, the system can execute the operation based on the context information and the input.

The techniques described herein can enable any suitable number of context based operations. For example, the techniques enable executing context based operations such as searching a data set based on context information associated with input, searching input and providing corresponding context information for the search results, aggregating input from multiple devices based on shared context information, generating labels based on context information, and the like.

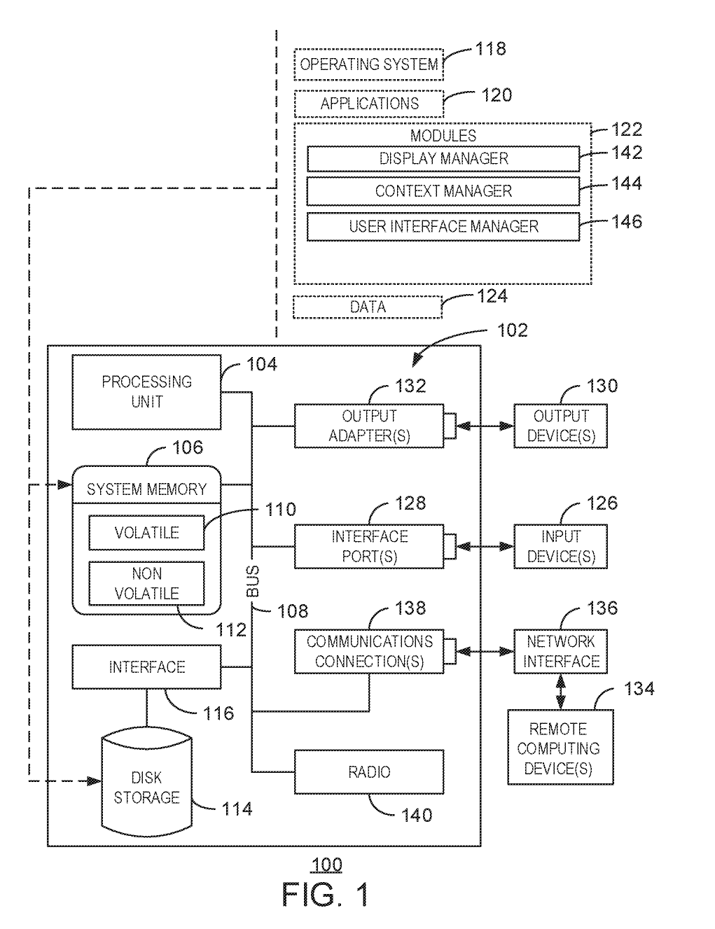

As a preliminary matter, some of the figures describe concepts in the context of one or more structural components, referred to as functionalities, modules, features, elements, etc. The various components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component. FIG. 1 discussed below, provide details regarding different systems that may be used to implement the functions shown in the figures.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computer systems, discrete logic components, such as application specific integrated circuits (ASICs), and the like, as well as any combinations thereof.

As for terminology, the phrase “configured to” encompasses any way that any kind of structural component can be constructed to perform an identified operation. The structural component can be configured to perform an operation using software, hardware, firmware and the like, or any combinations thereof. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable device, or media.

Computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not storage media) may additionally include communication media such as transmission media for wireless signals and the like.

FIG. 1 is a block diagram of an example of a computing system that can execute context based operations. The example system 100 includes a computing device 102. The computing device 102 includes a processing unit 104, a system memory 106, and a system bus 108. In some examples, the computing device 102 can be a gaming console, a personal computer (PC), an accessory console, a gaming controller, among other computing devices. In some examples, the computing device 102 can be a node in a cloud network.

The system bus 108 couples system components including, but not limited to, the system memory 106 to the processing unit 104. The processing unit 104 can be any of various available processors. Dual microprocessors and other multiprocessor architectures also can be employed as the processing unit 104.

The system bus 108 can be any of several types of bus structure, including the memory bus or memory controller, a peripheral bus or external bus, and a local bus using any variety of available bus architectures known to those of ordinary skill in the art. The system memory 106 includes computer-readable storage media that includes volatile memory 110 and nonvolatile memory 112.

In some embodiments, a unified extensible firmware interface (UEFI) manager or a basic input/output system (BIOS), containing the basic routines to transfer information between elements within the computer 102, such as during start-up, is stored in nonvolatile memory 112. By way of illustration, and not limitation, nonvolatile memory 112 can include read-only memory (ROM), programmable ROM (PROM), electrically programmable ROM (EPROM), electrically erasable programmable ROM (EEPROM), or flash memory.

Volatile memory 110 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 102 also includes other computer-readable media, such as removable/non-removable, volatile/non-volatile computer storage media. FIG. 1 shows, for example a disk storage 114. Disk storage 114 includes, but is not limited to, devices like a magnetic disk drive, floppy disk drive, tape drive, Jaz drive, Zip drive, LS-210 drive, flash memory card, or memory stick.

In addition, disk storage 114 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 114 to the system bus 108, a removable or non-removable interface is typically used such as interface 116.

It is to be appreciated that FIG. 1 describes software that acts as an intermediary between users and the basic computer resources described in the suitable operating environment 100. Such software includes an operating system 118. Operating system 118, which can be stored on disk storage 114, acts to control and allocate resources of the computer 102.

System applications 120 take advantage of the management of resources by operating system 118 through program modules 122 and program data 124 stored either in system memory 106 or on disk storage 114. It is to be appreciated that the disclosed subject matter can be implemented with various operating systems or combinations of operating systems.

A user enters commands or information into the computer 102 through input devices 126. Input devices 126 include, but are not limited to, a pointing device, such as, a mouse, trackball, stylus, and the like, a keyboard, a microphone, a joystick, a satellite dish, a scanner, a TV tuner card, a digital camera, a digital video camera, a web camera, any suitable dial accessory (physical or virtual), and the like. In some examples, an input device can include Natural User Interface (NUI) devices. NUI refers to any interface technology that enables a user to interact with a device in a “natural” manner, free from artificial constraints imposed by input devices such as mice, keyboards, remote controls, and the like. In some examples, NUI devices include devices relying on speech recognition, touch and stylus recognition, gesture recognition both on screen and adjacent to the screen, air gestures, head and eye tracking, voice and speech, vision, touch, gestures, and machine intelligence. For example, NUI devices can include touch sensitive displays, voice and speech recognition, intention and goal understanding, and motion gesture detection using depth cameras such as stereoscopic camera systems, infrared camera systems, RGB camera systems and combinations of these. NUI devices can also include motion gesture detection using accelerometers or gyroscopes, facial recognition, three-dimensional (3D) displays, head, eye, and gaze tracking, immersive augmented reality and virtual reality systems, all of which provide a more natural interface. NUI devices can also include technologies for sensing brain activity using electric field sensing electrodes. For example, a NUI device may use Electroencephalography (EEG) and related methods to detect electrical activity of the brain. The input devices 126 connect to the processing unit 104 through the system bus 108 via interface ports 128. Interface ports 128 include, for example, a serial port, a parallel port, a game port, and a universal serial bus (USB).

Output devices 130 use some of the same type of ports as input devices 126. Thus, for example, a USB port may be used to provide input to the computer 102 and to output information from computer 102 to an output device 130.

Output adapter 132 is provided to illustrate that there are some output devices 130 like monitors, speakers, and printers, among other output devices 130, which are accessible via adapters. The output adapters 132 include, by way of illustration and not limitation, video and sound cards that provide a means of connection between the output device 130 and the system bus 108. It can be noted that other devices and systems of devices provide both input and output capabilities such as remote computing devices 134.

The computer 102 can be a server hosting various software applications in a networked environment using logical connections to one or more remote computers, such as remote computing devices 134. The remote computing devices 134 may be client systems configured with web browsers, PC applications, mobile phone applications, and the like. The remote computing devices 134 can be a personal computer, a server, a router, a network PC, a workstation, a microprocessor based appliance, a mobile phone, a peer device or other common network node and the like, and typically includes many or all of the elements described relative to the computer 102.

Remote computing devices 134 can be logically connected to the computer 102 through a network interface 136 and then connected via a communication connection 138, which may be wireless. Network interface 136 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection 138 refers to the hardware/software employed to connect the network interface 136 to the bus 108. While communication connection 138 is shown for illustrative clarity inside computer 102, it can also be external to the computer 102. The hardware/software for connection to the network interface 136 may include, for exemplary purposes, internal and external technologies such as, mobile phone switches, modems including regular telephone grade modems, cable modems and DSL modems, ISDN adapters, and Ethernet cards.

The computer 102 can further include a radio 140. For example, the radio 140 can be a wireless local area network radio that may operate one or more wireless bands. For example, the radio 140 can operate on the industrial, scientific, and medical (ISM) radio band at 2.4 GHz or 5 GHz. In some examples, the radio 140 can operate on any suitable radio band at any radio frequency.

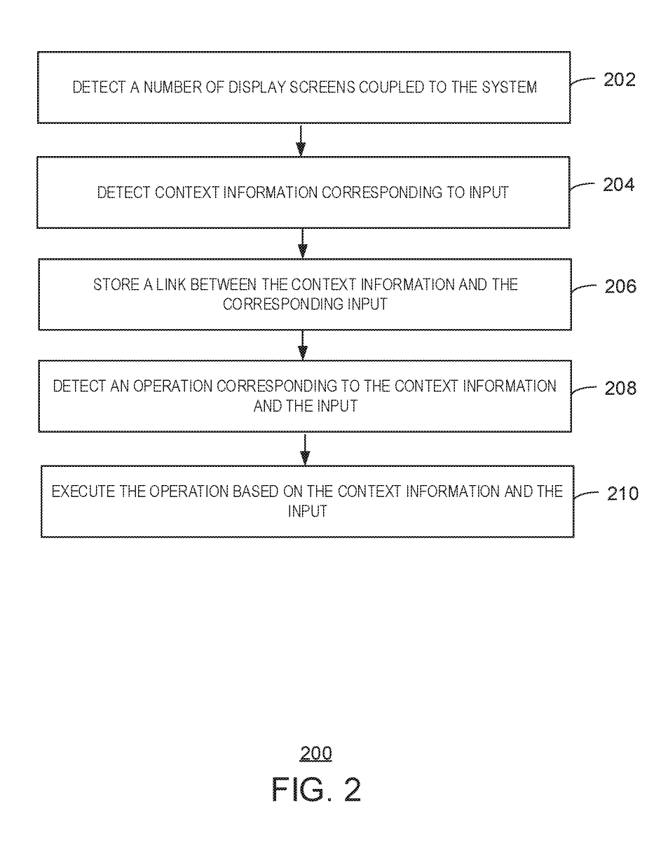

The computer 102 includes one or more modules 122, such as a display manager 142, a context manager 144, and a user interface manager 146. In some embodiments, the display manager 142 can detect a number of display screens coupled to a system. In some embodiments, the context manager 144 can detect context information corresponding to input detected via a user interface, wherein the context information can include device information, a subject of the input, device usage information, and the like. In some embodiments, the context manager 144 can also store a link between the context information and input. Additionally, the context manager 144 can detect an operation corresponding to the context information and the input. Furthermore, the user interface manager 146 can execute the operation based on the context information and the input. For example, the user interface manager 146 can modify a user interface to detect a reverse search query in which context information is searched for particular terms and the results for the reverse search query include context information and corresponding input. A reverse search or context based search can enable identifying previously viewed content based on context information. Additional context based operations are described in greater detail below in relation to FIG. 2.

It is to be understood that the block diagram of FIG. 1 is not intended to indicate that the computing system 102 is to include all of the components shown in FIG. 1. Rather, the computing system 102 can include fewer or additional components not illustrated in FIG. 1 (e.g., additional applications, additional modules, additional memory devices, additional network interfaces, etc.). Furthermore, any of the functionalities of the display manager 142, context manager 144, and user interface manager 146 may be partially, or entirely, implemented in hardware and/or in the processing unit (also referred to herein as a processor) 104. For example, the functionality may be implemented with an application specific integrated circuit, in logic implemented in the processing unit 104, or in any other device.

FIG. 2 is a process flow diagram of an example method for executing context based operations. The method 200 can be implemented with any suitable computing device, such as the computing system 102 of FIG. 1.

At block 202, a display manager 142 can detect device information such as a number of display screens coupled to the system. In some embodiments, the plurality of display screens can include two or more display screens attached to a single device. For example, a computing device may be electronically coupled to multiple display screens. Alternatively, a tablet computing device, a laptop device, and a mobile device may each be electronically coupled to separate display screens and a combination of the display screens for the tablet computing device, laptop device, and mobile device may be paired to display a shared user interface. In some embodiments, any two or more computing devices can be paired to display a user interface. For example, display screens for an augmented reality device, a projector device, a desktop computing system, a mobile device, a gaming console, a virtual reality device, a holographic projection display, or any combination therefore, can be combined to display a user interface. In some examples, the display screens can reside within a virtual reality headset. In some embodiments, at least one of the display screens can correspond to a virtual desktop. In some examples, one device can be coupled to a single display screen and a paired device can be coupled to multiple display screens.

At block 204, a context manager 144 can detect context information corresponding to input. In some examples, as discussed above, the context information can include device information, a subject of the input, device usage information, or a combination thereof. Additionally, the context information can include user position information, user attention information, and the like. User position information can indicate a physical location of a user from a global positioning satellite, among other sensors. In some examples, the user attention information can indicate if a user is viewing a particular display device based on sensor information from cameras, gyrometers, and the like. The context information can also include an application state at a time that input is detected.

In some embodiments, the input can be detected by an input panel displayed with a user interface on a first display screen and the context information can correspond to content displayed on a second interconnected display screen. In some examples, the input can be detected or captured with a keyboard, by a camera, or by contacting one of a plurality of display screens. For example, the input can include a photograph of a whiteboard, handwritten notes provided to a device with a stylus, and the like. In some embodiments, the content can include a web page, electronic book, document, video, or an audio file, among others. In some examples, the context manager 144 can continuously associate content displayed on a second display screen with input detected on a first display screen. Accordingly, the context manager 144 can enable operations executed based on context information, input, or a combination thereof. For example, the context manager 144 can enable searching context information in order to perform a reverse search to identify previously detected input.

In some embodiments, context information can also include a screenshot from one of a plurality of display screens, wherein the screenshot is captured at a time of input being detected. In some embodiments, context information can include a selection of content from one of a plurality of display screens. For example, the selection can correspond to a portion of content circled or otherwise selected with a stylus, mouse, or any other suitable input device. In some examples, the screenshot can include content displayed by any two or more display devices connected to a system. For example, a first display device may provide an input panel and two additional display devices may provide additional content. In some embodiments, the context manager 144 can store screenshots of the two additional display devices. In some embodiments, context information corresponds to a symbol captured in the input. For example, an input panel can detect an arrow to content displayed on a separate display device. The arrow can indicate that input corresponds to particular content being displayed separately.

Furthermore, still at block 204, context information can indicate a viewed portion of a video, an electronic book, or a website based on a stored font and an amount scrolled. For example, the context information can indicate a portion of content that was displayed or provided to a user as input was detected based on a frame of video being displayed, a portion of an electronic book or document being displayed, and the like. In some examples, context information can also include a location of a system at a time related to detecting input and an indication of whether the system is in motion.

At block 206, the context manager 144 can store a link between the context information and the corresponding input. For example, the context manager 144 can generate any suitable data structure, such as a linked list, vector, array, and the like, to store a link or mapping between input and corresponding context information. In some examples, the context manager 144 can store a linked screenshot of a user interface or a connected display device, wherein the screenshot corresponds to detected input. In some embodiments, the context manager 144 can link any suitable amount of context information associated with detected input. For example, the context manager 144 can store a link between detected input and context information comprising a time of day of the detected input, a location of a device at the time of the detected input, whether the device was in motion at the time of the detected input, a device configuration at the time of the detected input, a user's gaze at the time of the detected input, and the like.

At block 208, the context manager 144 can detect an operation corresponding to the context information and the input. The operation can include the reverse search described above or a search based on previously detected input. A reverse search or context based search can enable identifying previously viewed content based on context information. For example, a context based search can generate search results based on previous phone calls, emails, text or images identified from screenshots, or locations of a device, among others. In some examples, the search results can also include the corresponding input associated with the context information. Accordingly, a reverse search can enable identifying portions of input or input items previously entered based on what a user was viewing on a display device while the input was provided.

Alternatively, an input based search can return search results including portions of input that match a search query. In some embodiments, the corresponding context information can be displayed proximate or adjacent to the search query results. Accordingly, the context manager 144 can enable searching previously stored input or context information and returning portions of the stored input and associated or linked context information. For example, a search query can search stored input and return a list of input items, such as bullet points, paragraphs, documents, and the like, corresponding to a particular term along with the linked context information for each input item. As discussed above, the context information can include data such as screenshots, device locations, time of day, and device configuration, among others.

Still at block 208, in some embodiments, the context based operation can include extracting text from a screenshot of a display screen. For example, the operation can include performing optical character recognition or any other suitable imaging technique with screenshots of context. For example, the operation can include applying a machine learning technique to screenshots to determine a subject matter of the image. In some embodiments, the subject matter of the screenshots can be stored for search queries. For example, a plurality of screenshots may include an image of an object. The operation can include identifying the object and associating input with the object for future search queries. Accordingly, the operation can include applying image analysis to a screenshot of a display screen and storing image data detected from the image analysis as context information.

In some embodiments, the operation can include identifying and selecting multiple items of input that share a common context. For example, input can include any number of sections, bullet points, paragraphs, and the like. The operation can include identifying context displayed as the input was detected and selecting any items of the input with a common or shared context. For example, multiple sections of input entered while viewing a particular object or class of objects can be selected. In some embodiments, items of input can also be identified and selected based on additional context information such as a common location of a device, a shared time of day for the input, and the like. In some embodiments, selecting items from input can enable a user to perform operations on the selected items. Similarly, in some examples, the operation can include sharing or deleting multiple items of input that share a common context. For example, the operation can include transmitting input items with a shared context to additional devices or deleting the input items with a shared context. In some examples, the operation can also include generating a label corresponding to input based on context information. For example, the operation can include detecting a subject corresponding to input based on context information and generating a label including the subject. In some examples, the subject can be based on common images in the context information, text retrieved from screenshots in the context information, classes of objects identified within the context information, and the like.

At block 210, the user interface manager 146 can execute the operation based on the context information and the input. In some embodiments, the user interface manager 146 can execute any suitable operation such as a search based on image data detected from a screenshot, among others. For example, the user interface manager 146 can detect a reverse search query based on context information. The user interface manager 146 can execute the reverse search query based on context information retrieved from screenshots such as text retrieved using optical character recognition techniques from screenshots of content corresponding to input. In some embodiments, the user interface manager 146 can execute a reverse search for input detected during a phone call to a particular phone number, input detected as a device was in a particular location, input detected as a device was in motion, input detected while a user is physically collocated with another user, or input detected at a time of day or on a particular date, among others.

In some embodiments, the user interface manager 146 can detect a gesture and display the context information corresponding to the input. The gesture can indicate that context information is to be associated with input or that context information associated with input is to be displayed. In some examples, the gesture can include actions performed with a stylus including a button press on the stylus or a related touch gesture on a screen, or any number of fingers or any other portion of a hand or hands interacting with a display screen. For example, the gesture can include a one finger touch of the display screen, a two finger touch of the display screen, or any additional number of fingers touching the display screen. In some embodiments, the gesture can include two hands contacting a display screen within a size and shape of a region of the display screen in which a gesture can be detected. In some examples, the area of the region corresponds to any suitable touch of a display screen. For example, a first finger touching the display screen can indicate that additional fingers or hands touching the display screen can be considered part of the gesture within a particular distance from the first finger contact. In some embodiments, the gesture can also include a temporal component. For example, the gesture may include any number of fingers or hands contacting the display screen within a particular region within a particular time frame. In some examples, a delay between touching two fingers to the display screen can result in separate gestures being detected.

Still at block 210, in some embodiments, the user interface manager 146 can detect that input relates to an incomplete section of notes and auto-complete the incomplete section of notes based on content from additional devices sharing the same context information. For example, the user interface manager 146 can determine that context information, such as a location of a plurality of devices and a time of input entered into the plurality of devices, is similar or the same. The user interface manager 146 can determine that the input detected by the plurality of devices is related and pertains to common subject matter. Accordingly, the user interface manager 146 can auto-complete incomplete sections of notes or input based on additional input detected by separate devices. For example, a first device detecting notes during a presentation or lecture can transmit the notes as input or context to a second device. In some embodiments, the user interface manager 146 can execute search queries based on input or context information stored by remote users.

In one embodiment, the process flow diagram of FIG. 2 is intended to indicate that the blocks of the method 200 are to be executed in a particular order. Alternatively, in other embodiments, the blocks of the method 200 can be executed in any suitable order and any suitable number of the blocks of the method 200 can be included. Further, any number of additional blocks may be included within the method 200, depending on the specific application. In some embodiments, the method 200 can include shrinking a screenshot of content viewed while input is detected and inserting the shrunken screenshot into the input. In some examples, capturing the context information can be modeless or can be a setting or mode selected by a user. In some embodiments, the method 200 can include detecting a selection of input and a selection of a menu option resulting in context information associated with the selected input being displayed. For example, the menu option can enable viewing the various context information associated with input, wherein the context information can include a configuration of a device, a location of the device, a time of day, a user's relation to the device, and the like. In some embodiments, the method 200 can include modifying the context information at a later time, in which additional information or content can be added to context information associated with input.

In some examples, the method 200 can include displaying an option to scroll forward or backward in time to view different context information. For example, the method 200 can include scrolling forward or backward to view different screenshots captured based on a time of the screenshots. In some embodiments, the context information can also indicate if a device was in motion as input was detected and indicate a location of the device on a map. In some embodiments, the context manager 144 can also detect if content is viewable based on a device configuration. For example, a device configured in a tablet mode can result in a display device for displaying content facing away from a user. For example, a device with multiple display screens operating in tablet mode may include a display screen facing a user and a display screen facing away from the user. Accordingly, the content corresponding to the display screen facing away from the user may not be associated with input.

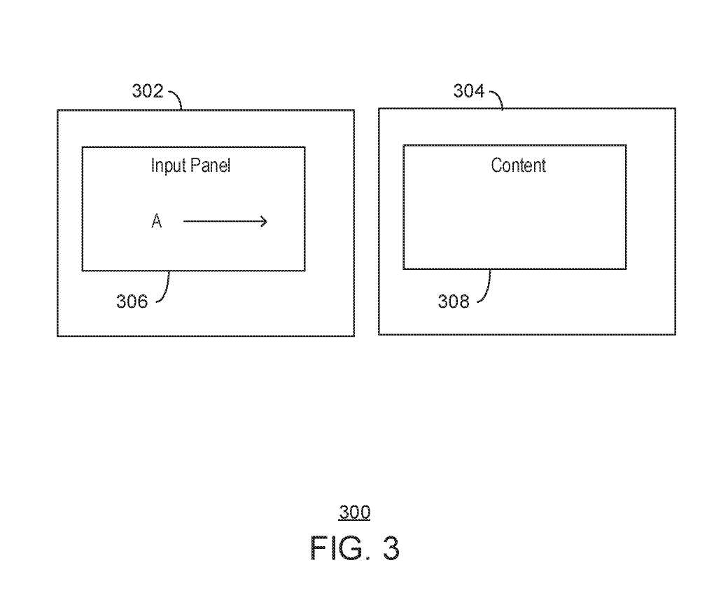

FIG. 3 is an example block diagram illustrating a user interface for executing context based operations. In the user interface 300, two display screens 302 and 304 display an application window. As discussed above, an input panel 306 can be displayed in display screen 302 and additional content 308 can be displayed on display screen 304. For example, the additional content can include a web page, electronic book, video, or an audio file, among others. In some embodiments, the display screens 302 and 304 can be located proximate one another to enable a user to view both display screens 302 and 304 simultaneously. Accordingly, input provided to an input panel 306 displayed in display screen 302 can be linked to content 308 displayed on display screen 304. For example, input “A” detected by the input panel 306 can include an arrow indicating an association with content 308 displayed by display screen 304. In some embodiments, the content 308 visible to a user can be stored as context information in addition to data such as a user's eye gaze, configuration of a device in a laptop mode or a tablet mode, a number of display devices coupled to a system, whether a user is standing or walking, a size of the display devices, whether the display devices are visible to user, and a relationship or layout between the input panel and the display screen with additional content, among others. In some examples, as discussed above, context information corresponding to the input panel 306 can be continuously stored along with detected input to provide various operations such as context based search operations and the like.

It is to be understood that the block diagram of FIG. 3 is not intended to indicate that the user interface 300 contain all of the components shown in FIG. 3. Rather, the user interface 300 can include fewer or additional components not illustrated in FIG. 3 (e.g., additional application windows, display screens, etc.).

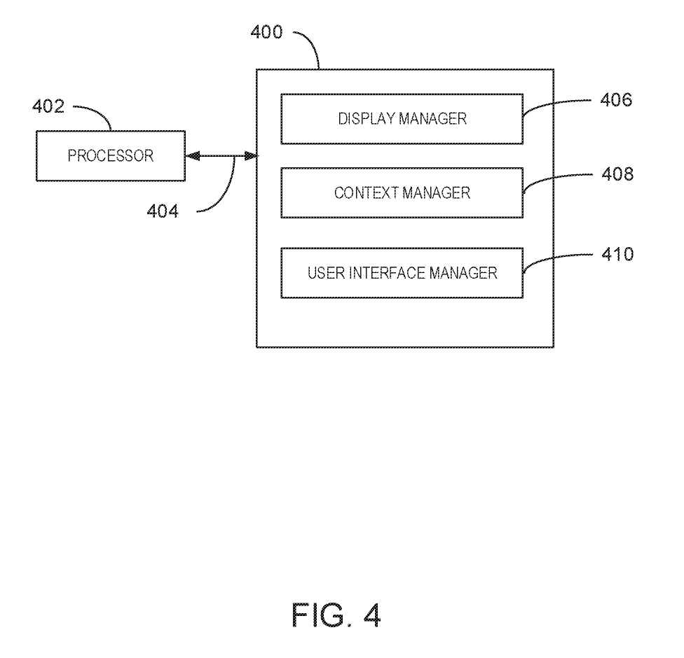

FIG. 4 is a block diagram of an example computer-readable storage media that can execute context based operations. The tangible, computer-readable storage media 400 may be accessed by a processor 402 over a computer bus 404. Furthermore, the tangible, computer-readable storage media 400 may include code to direct the processor 402 to perform the steps of the current method.

The various software components discussed herein may be stored on the tangible, computer-readable storage media 400, as indicated in FIG. 4. For example, the tangible computer-readable storage media 400 can include a display manager 406 that can detect a number of display screens coupled to the system. In some embodiments, a context manager 408 can detect context information corresponding to input wherein the context information comprises device information, a subject of the input, device usage information, or a combination thereof. The context manager 408 can also store a link between input and context information. Additionally, the context manager 408 can detect an operation corresponding to the context information and the input. Furthermore, a user interface manager 410 can execute the operation based on the context information and the input.

It is to be understood that any number of additional software components not shown in FIG. 4 may be included within the tangible, computer-readable storage media 400, depending on the specific application.

### Example 1

In one embodiment, a system for context based operations can include a processor and a memory device comprising a plurality of instructions that, in response to an execution by the processor, cause the processor to detect context information corresponding to input, wherein the context information comprises device information, a screenshot of a user interface, device usage information, or a combination thereof. The processor can also detect an operation corresponding to the context information and the input and execute the operation based on the context information and the input.

Alternatively, or in addition, the operation comprises a reverse search based on the context information related to a phone call. Alternatively, or in addition, the operation comprises an input based search. Alternatively, or in addition, the system comprises two display screens and the context information corresponds to a first of the two display screens and the input is detected with a second of the two display screens. Alternatively, or in addition, the context information comprises a screenshot from the first of the two display screens, wherein the screenshot is captured at a time of the input being detected. Alternatively, or in addition, the context information comprises a selection of content from the first of the two display screens. Alternatively, or in addition, the context information corresponds to a symbol captured in the input. Alternatively, or in addition, the context information indicates a position in a video, an electronic book, or a website based on a stored font and an amount scrolled. Alternatively, or in addition, the input is to be captured with a keyboard, by a camera, or by contacting the second of the display screens with a stylus or a user's hand. Alternatively, or in addition, the operation comprises extracting text from a screenshot of the first display screen. Alternatively, or in addition, the operation comprises applying image analysis to a screenshot of the first display screen and storing image data detected from the image analysis as context information. Alternatively, or in addition, the plurality of instructions cause the processor to execute a search based on the image data. Alternatively, or in addition, the plurality of instructions cause the processor to detect a gesture and display the context information corresponding to the input. Alternatively, or in addition, the context information comprises a location of the system at a time related to detecting the input. Alternatively, or in addition, the plurality of instructions cause the processor to detect the input relates to an incomplete section of notes and auto-complete the incomplete section of notes based on content from additional devices sharing the same context information or from a web service storing the content for the additional devices. Alternatively, or in addition, the operation comprises identifying and automatically selecting multiple items of the input that share common context information. Alternatively, or in addition, the operation comprises sharing or deleting multiple items of the input that share common context information. Alternatively, or in addition, the operation comprises generating a label corresponding to the input based on the context information.

### Example 2

In some examples, a method for context based operations can include detecting context information corresponding to input, wherein the context information comprises device information, device usage information, or a combination thereof, wherein the device information indicates two display screens are connected to a device and the context information corresponds to a first of the two display screens and the input is detected with a second of the two display screens. The method can also include storing a link between the context information and the corresponding input and detecting an operation corresponding to the context information. Furthermore, the method can include executing the operation based on the context information and the corresponding input, wherein the operation comprises a reverse search query based on the context information, and wherein a result of the reverse search query comprises previously detected input corresponding to the context information.

Alternatively, or in addition, the operation comprises an input based search. Alternatively, or in addition, the system comprises two display screens and the context information corresponds to a first of the two display screens and the input is detected with a second of the two display screens. Alternatively, or in addition, the context information comprises a screenshot from the first of the two display screens, wherein the screenshot is captured at a time of the input being detected. Alternatively, or in addition, the context information comprises a selection of content from the first of the two display screens. Alternatively, or in addition, the context information corresponds to a symbol captured in the input. Alternatively, or in addition, the context information indicates a position in a video, an electronic book, or a website based on a stored font and an amount scrolled. Alternatively, or in addition, the input is to be captured with a keyboard, by a camera, or by contacting the second of the display screens with a stylus or a user's hand. Alternatively, or in addition, the operation comprises extracting text from a screenshot of the first display screen. Alternatively, or in addition, the operation comprises applying image analysis to a screenshot of the first display screen and storing image data detected from the image analysis as context information. Alternatively, or in addition, the method includes executing a search based on the image data. Alternatively, or in addition, the method includes detecting a gesture and displaying the context information corresponding to the input. Alternatively, or in addition, the context information comprises a location of the system at a time related to detecting the input. Alternatively, or in addition, the method includes detecting the input relates to an incomplete section of notes and auto-completing the incomplete section of notes based on content from additional devices sharing the same context information or from a web service storing the content for the additional devices. Alternatively, or in addition, the operation comprises identifying and automatically selecting multiple items of the input that share common context information. Alternatively, or in addition, the operation comprises sharing or deleting multiple items of the input that share common context information. Alternatively, or in addition, the operation comprises generating a label corresponding to the input based on the context information.

### Example 3

In some examples, one or more computer-readable storage media for context based operations can include a plurality of instructions that, in response to execution by a processor, cause the processor to detect context information corresponding to input, wherein the context information comprises device information, a subject of the input, device usage information, or a combination thereof, wherein the device information indicates two display screens are coupled to a system and the context information corresponds to a first of the two display screens and the input is detected with a second of the two display screens. The plurality of instructions can also cause the processor to store a link between the context information and the corresponding input, detect an operation corresponding to the context information and the input, and execute the operation based on the context information and the input.

Alternatively, or in addition, the operation comprises a reverse search based on the context information related to a phone call. Alternatively, or in addition, the operation comprises an input based search. Alternatively, or in addition, the system comprises two display screens and the context information corresponds to a first of the two display screens and the input is detected with a second of the two display screens. Alternatively, or in addition, the context information comprises a screenshot from the first of the two display screens, wherein the screenshot is captured at a time of the input being detected. Alternatively, or in addition, the context information comprises a selection of content from the first of the two display screens. Alternatively, or in addition, the context information corresponds to a symbol captured in the input. Alternatively, or in addition, the context information indicates a position in a video, an electronic book, or a website based on a stored font and an amount scrolled. Alternatively, or in addition, the input is to be captured with a keyboard, by a camera, or by contacting the second of the display screens with a stylus or a user's hand. Alternatively, or in addition, the operation comprises extracting text from a screenshot of the first display screen. Alternatively, or in addition, the operation comprises applying image analysis to a screenshot of the first display screen and storing image data detected from the image analysis as context information. Alternatively, or in addition, the plurality of instructions cause the processor to execute a search based on the image data. Alternatively, or in addition, the plurality of instructions cause the processor to detect a gesture and display the context information corresponding to the input. Alternatively, or in addition, the context information comprises a location of the system at a time related to detecting the input. Alternatively, or in addition, the plurality of instructions cause the processor to detect the input relates to an incomplete section of notes and auto-complete the incomplete section of notes based on content from additional devices sharing the same context information or from a web service storing the content for the additional devices. Alternatively, or in addition, the operation comprises identifying and automatically selecting multiple items of the input that share common context information. Alternatively, or in addition, the operation comprises sharing or deleting multiple items of the input that share common context information. Alternatively, or in addition, the operation comprises generating a label corresponding to the input based on the context information.

In particular and in regard to the various functions performed by the above described components, devices, circuits, systems and the like, the terms (including a reference to a “means”) used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interoperation between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system for context based operations comprising:
a processor; and
a memory device comprising a plurality of instructions that, in response to an execution by the processor, cause the processor to:
detect context information corresponding to input, wherein the context information comprises device information, a screenshot of a user interface, device usage information, or a combination thereof;
detect an operation corresponding to the context information and the input; and
execute the operation based on the context information and the input.

2. The system of claim 1, wherein the operation comprises a reverse search based on the context information related to a phone call.

3. The system of claim 1, wherein the operation comprises an input based search.

4. The system of claim 1, wherein the system comprises two display screens and the context information corresponds to a first of the two display screens and the input is detected with a second of the two display screens.

5. The system of claim 4, wherein the context information comprises a screenshot from the first of the two display screens, wherein the screenshot is captured at a time of the input being detected.

6. The system of claim 4, wherein the context information comprises a selection of content from the first of the two display screens.

7. The system of claim 4, wherein the context information corresponds to a symbol captured in the input.

8. The system of claim 4, wherein the context information indicates a position in a video, an electronic book, or a website based on a stored font and an amount scrolled.

9. The system of claim 4, wherein the input is to be captured with a keyboard, by a camera, or by contacting the second of the display screens with a stylus or a user's hand.

10. The system of claim 4, wherein the operation comprises extracting text from a screenshot of the first display screen.

11. The system of claim 4, wherein the operation comprises applying image analysis to a screenshot of the first display screen and storing image data detected from the image analysis as context information.

12. The system of claim 11, wherein the plurality of instructions cause the processor to execute a search based on the image data.

13. The system of claim 4, wherein the plurality of instructions cause the processor to detect a gesture and display the context information corresponding to the input.

14. The system of claim 4, wherein the context information comprises a location of the system at a time related to detecting the input.

15. The system of claim 4, wherein the plurality of instructions cause the processor to:
detect the input relates to an incomplete section of notes; and
auto-complete the incomplete section of notes based on content from additional devices sharing the same context information or from a web service storing the content for the additional devices.

16. The system of claim 4, wherein the operation comprises identifying and automatically selecting multiple items of the input that share common context information.

17. The system of claim 4, wherein the operation comprises sharing or deleting multiple items of the input that share common context information.

18. The system of claim 4, wherein the operation comprises generating a label corresponding to the input based on the context information.

19. A method for context based operations comprising:
detecting context information corresponding to input, wherein the context information comprises device information, device usage information, or a combination thereof, wherein the device information indicates two display screens are connected to a device and the context information corresponds to a first of the two display screens and the input is detected with a second of the two display screens;
storing a link between the context information and the corresponding input;
detecting an operation corresponding to the context information; and
executing the operation based on the context information and the corresponding input, wherein the operation comprises a reverse search query based on the context information, and wherein a result of the reverse search query comprises previously detected input corresponding to the context information.

20. One or more computer-readable storage media for context based operations comprising a plurality of instructions that, in response to execution by a processor, cause the processor to:
detect context information corresponding to input, wherein the context information comprises device information, a subject of the input, device usage information, or a combination thereof, wherein the device information indicates two display screens are coupled to a system and the context information corresponds to a first of the two display screens and the input is detected with a second of the two display screens;
store a link between the context information and the corresponding input;
detect an operation corresponding to the context information and the input; and
execute the operation based on the context information and the input.
